(19) United States
(12) Patent Application Publication
(10) Pub. No.: US 2025/0386237 A1
(43) Pub. Date: Dec. 18, 2025

(54) REQUEST AND REPORT OF MLD LEVEL STATISTIC AND DELAY INFORMATION

(71) Applicant: Nokia Technologies Oy, Espoo (FI)

(72) Inventors: Zhijie YANG, Shanghai (CN); Mika KASSLIN, Espoo (FI); Lorenzo GALATI GIORDANO, Stuttgart (DE); Orhan Okan MUTGAN, Munich (DE)

(21) Appl. No.: 18/878,977

(22) PCT Filed: Jul. 7, 2022
(86) PCT No.: PCT/CN2022/104433

§ 371 Date: Dec. 26, 2024

(51) Int. Cl. H04W 28/02; H04W 88/06

(52) U.S. Cl. CPC H04W 28/0236; H04W 88/06

(57) ABSTRACT

Embodiments of the present disclosure relate to MLDs, methods, apparatuses and computer readable storage media for request and report of MLD level statistic and delay information. An MLD determines at least one of statistic information associated with the MLD or delay information associated with the MLD. In response to receiving a request for the at least one of the statistic information or the delay information from a second MLD, the MLD transmits the at least one of the statistic information or the delay information to the second MLD.

### FIELD

Embodiments of the present disclosure generally relate to the field of telecommunication and, in particular, to multi-link devices (MLDs), methods, and computer readable storage media for request and report of MLD level statistic and delay information.

### BACKGROUND

Institute of Electrical and Electronics Engineers (IEEE) Task Group (TG) be defines an MLD architecture. In the MLD architecture, one MLD may establish multiple links with a further MLD and transmit data to the further MLD on the multiple links simultaneously. For example, an AP MLD may establish three links on 2.4 GHz, 5 GHz and 6 GHz bands with a non-AP MLD and transmit data to the non-AP MLD on the three links simultaneously. Compared to pre-802.11be architecture, the MLD architecture improves throughput (TP) and reduces latency significantly.

### SUMMARY

Example embodiments of the present disclosure provide an improved solution for request and report of MLD level statistic and delay information.

In a first aspect, there is provided an MLD. The MLD comprises at least one processor and at least one memory storing instructions. The instructions, when executed by the at least one processor, cause the MLD at least to: determine at least one of statistic information associated with the MLD or delay information associated with the MLD; in response to receiving a request for the at least one of the statistic information or the delay information from a second MLD, transmit the at least one of the statistic information or the delay information to the second MLD.

In a second aspect, there is provided an MLD. The MLD comprises at least one processor and at least one memory storing instructions. The instructions, when executed by the at least one processor, cause the MLD at least to: transmit, to a first MLD, a request for at least one of statistic information associated with the first MLD or delay information associated with the first MLD; and receive, from the first MLD, a report on the at least one of the statistic information or the delay information.

In a third aspect, there is provided a method. The method comprises: determining, at an MLD, at least one of statistic information associated with the MLD or delay information associated with the MLD; and in response to receiving a request for the at least one of the statistic information or the delay information from a second MLD, transmitting the at least one of the statistic information or the delay information to the second MLD.

In a fourth aspect, there is provided a method. The method comprises: transmitting, from an MLD to a first MLD, a request for at least one of statistic information associated with the first MLD or delay information associated with the first MLD; and receiving, from the first MLD, a report on the at least one of the statistic information or the delay information.

In a fifth aspect, there is provided an apparatus comprising a first MLD. The first MLD has: means for determining at least one of statistic information associated with the first MLD or delay information associated with the first MLD; means for transmitting the at least one of the statistic information or the delay information to a second MLD in response to receiving a request for the at least one of the statistic information or the delay information from the second MLD.

In a sixth aspect, there is provided an apparatus comprising a second MLD. The second MLD has: means for transmitting, to a first MLD, a request for at least one of statistic information associated with the first MLD or delay information associated with the first MLD; and means for receiving, from the first MLD, a report on the at least one of the statistic information or the delay information.

In a seventh aspect, there is provided a computer readable medium. The non-transitory computer readable medium comprises program instructions for causing an apparatus to perform the method according to the third aspect.

In an eighth aspect, there is provided a computer readable medium. The non-transitory computer readable medium comprises program instructions for causing an apparatus to perform the method according to the fourth aspect.

It is to be understood that the summary section is not intended to necessarily identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example implementations will now be described with reference to the accompanying drawings, where:

FIG. 1A illustrates an example communication environment in which embodiments of the present disclosure can be implemented;

FIG. 1B illustrates another example communication environment in which embodiments of the present disclosure can be implemented;

FIG. 1C illustrates yet another example communication environment in which embodiments of the present disclosure can be implemented;

FIGS. 2A and 2B illustrate an example of difference between link level statistics and delay information and MLD level statistics and delay information in accordance with some example implementations of the present disclosure, respectively;

FIG. 3 illustrates a signaling chart illustrating a process for request and report of at least one of statistic information or delay information associated with an MLD in accordance with some example embodiments of the present disclosure;

FIGS. 4A and 4B illustrate an example of a station statistics request frame in accordance with some example embodiments of the present disclosure, respectively;

FIG. 4C illustrates an example of a station statistics report frame in accordance with some example embodiments of the present disclosure;

FIG. 5 illustrates a signaling chart illustrating a process for request and report of at least one of statistic information or delay information associated with an MLD in accordance with some example embodiments of the present disclosure;

FIG. 6 illustrates a flowchart of an example method in accordance with some example implementations of the present disclosure;

FIG. 7 illustrates a flowchart of an example method in accordance with other example implementations of the present disclosure;

FIG. 8 illustrates a simplified block diagram of an apparatus that is suitable for implementing example implementations of the present disclosure; and

FIG. 9 illustrates a block diagram of an example computer readable medium in accordance with example implementations of the present disclosure.

Throughout the drawings, the same or similar reference numerals represent the same or similar element, unless otherwise provided.

### DETAILED DESCRIPTION

Principles of the present disclosure will now be described with reference to some example implementations. It is to be understood that these implementations are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as, but not limited to, fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT), Wi-Fi and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned systems.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (also known as a relay node). In the following description, the terms “terminal device”, “communication device”, “terminal”, “user equipment” and “UE” may be used interchangeably.

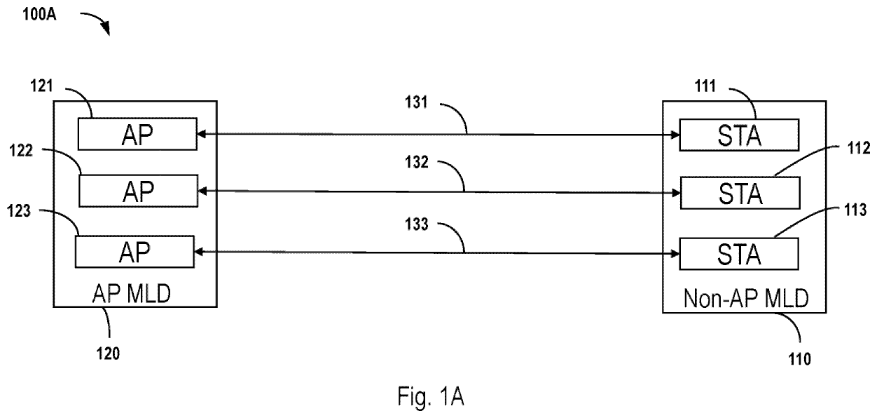

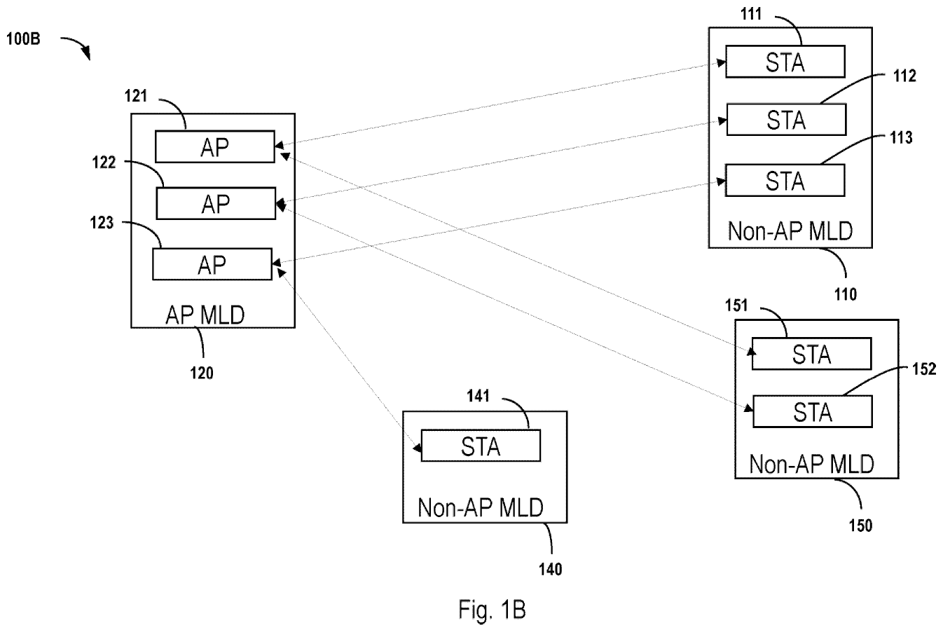

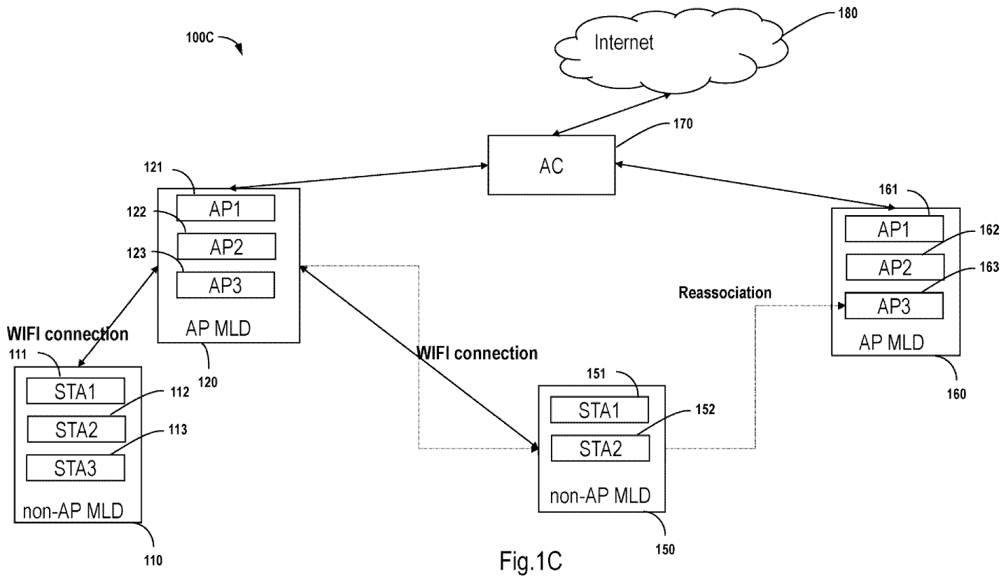

FIG. 1A illustrates an example communication environment 100A in which embodiments of the present disclosure can be implemented. In some embodiments, the communication environment 100A may be implemented as an easy mesh network (ESS).

As shown in FIG. 1A, the communication environment 100A comprises a non-AP MLD 110 and an AP MLD 120. It will be understood that an MLD is a logical entity. An MLD acting as an AP entity may be referred to as an AP MLD, and an MLD acting as a non-AP STA entity may be referred to as a non-AP MLD.

The non-AP MLD 110 has affiliated non-AP STAs 111, 112 and 113. Hereinafter, a non-AP STA is also referred to as STA for brevity. The AP MLD 120 has affiliated APs 121, 122 and 123.

The AP MLD 120 may establish three links with the non-AP MLD 110 and transmit data to the non-AP MLD 110 on the three links simultaneously. The three links may comprise a link 131 between the AP 121 and the STA 111, a link 132 between the AP 122 and the STA 112, and a link 133 between the AP 123 and the STA 113. For example, the three links may operate on 2.4 GHz, 5 GHz and 6 GHz bands, respectively.

It is to be understood that the number of the non-AP STAs affiliated with the non-AP MLD 110 and the number of the APs affiliated with the AP MLD 120 as shown in FIG. 1A are only for the purpose of illustration without suggesting any limitations. The communication environment 100A may include any suitable number of STAs affiliated with the non-AP MLD 110 and any suitable number of APs affiliated with the AP MLD 120 adapted for implementing embodiments of the present disclosure.

In addition, it is to be understood that the number of the non-AP MLDs as shown in FIG. 1A is also only for the purpose of illustration without suggesting any limitations. The communication environment 100A may include any suitable number of non-AP MLDs adapted for implementing embodiments of the present disclosure. In some embodiments, the AP MLD 120 may establish links with a plurality of non-AP MLDs. This will be described with reference to FIG. 1B.

FIG. 1B illustrates another example communication environment 100B in which embodiments of the present disclosure can be implemented. In some embodiments, the communication environment 100B may be implemented as an ESS.

As shown in FIG. 1B, the communication environment 100B comprises the non-AP MLD 110 and the AP MLD 120 as shown in FIG. 1A as well as non-AP MLDs 140 and 150.

The non-AP MLD 140 has an affiliated non-AP STA 141. The non-AP MLD 150 has affiliated non-AP STAs 151 and 152.

The AP MLD 120 may establish a link with the non-AP MLD 140 and the link is between the AP 123 and the STA 141. The AP MLD 120 may establish two links with the non-AP MLD 150. One of the two links is between the AP 121 and the STA 151 and the other is between the AP 122 and the STA 152.

FIG. 1C illustrates yet another example communication environment 100C in which embodiments of the present disclosure can be implemented. In some embodiments, the communication environment 100C may be implemented as an ESS.

As shown in FIG. 1C, the communication environment 100C comprises the AP MLD 120, the non-AP MLDs 110 and 150 as shown in FIG. 1B as well as an AP MLD 160, an access control (AC) device 170 and an Internet 180. The AP MLD 160 has affiliated APs 161, 162 and 163.

It shall be understood that FIG. 1C illustrates that the AC device 170 is separate from the AP MLDs 120 and 160 by way of example. In some embodiments, the AC device 170 may be incorporated into one of the AP MLDs 120 and 160.

In some embodiments, each of an AP affiliated with an AP MLD and a STA affiliated with a non-AP MLD may be configured with STA statistic counters (also referred to as link level counters). The STA statistic counters may store statistic information associated with a link between the AP and the STA. In addition, each of the AP and the STA may maintain delay information associated with the link between the AP and the STA. Delivery status of the AP or STA may be determined based on the statistic information associated with the link or the delay information associated with the link. Hereinafter, statistics information associated with a link and delay information associated with a link are also referred to as link level statistics information and link level delay information, respectively. For brevity, link level statistics information and link level delay information is collectively referred to as link level statistics and delay information.

The AP may obtain the link level statistics and delay information from the connected STA. Similarly, the STA may obtain the link level statistics and delay information from the AP. For example, the AP 121 may obtain statistics and delay information associated with the link 131 from the STA 111, and the STA 112 may obtain statistics and delay information associated with the link 132 from the AP 122.

In some embodiments, an MLD (such as the AP MLD 120) may need to obtain at least one of statistics information or delay information associated with another MLD (such as the non-AP MLD 110) so as to make a decision, such as a decision on traffic scheduling and/or load balancing. In addition, the non-AP MLD 110 may need to make a decision on continuing to connect to the AP MLD 120 or connect to a neighbor AP MLD so as to improve its performance. Hereinafter, statistics information associated with an MLD and delay information associated with the MLD is referred to as ML level statistics information and ML level delay information, respectively. For brevity, MLD level statistics information and MLD level delay information is collectively referred to as MLD level statistics and delay information.

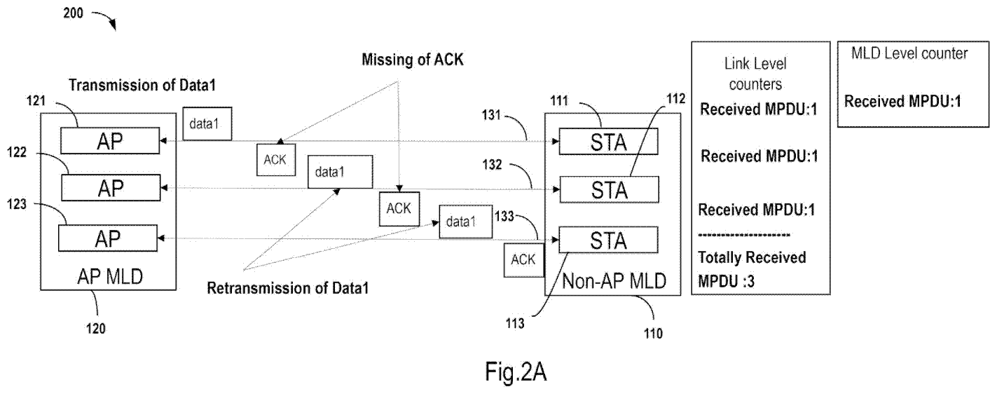

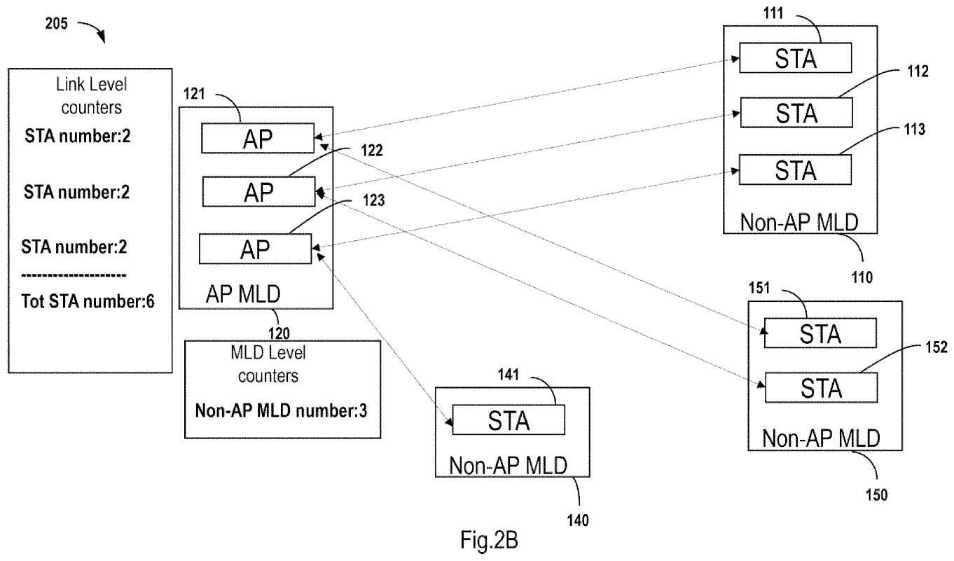

In case where multiple links are established between the two MLDs, the link level statistics and delay information may be different from the MLD level statistics and delay information. Thus, information error may occur if an MLD makes a decision based on the link level counters. This will be described with reference to FIGS. 2A and 2B.

FIG. 2A illustrates an example 200 of difference between link level statistics and delay information and MLD level statistics and delay information. The example 200 may involve the AP MLD 120 and the non-AP MLD 110 as illustrated in FIG. 1A.

The AP MLD 120 transmits datal to the non-AP MLD 110 via the AP 121. The non-AP MLD 110 will respond with ACK via the STA 111. However, the ACK frame is missing due to interference on the channel. Then, the AP MLD 120 may retransmit datal to the non-AP MLD 110 via the AP 122. The non-AP MLD 110 will respond with ACK via the STA 112. However, the ACK frame is missing again. The AP MLD 120 retransmits datal to the non-AP MLD 110 via the AP 123. The STA 113 affiliated with the non-AP MLD 110 will respond with ACK, which is finally received by the AP MLD 110.

The AP MLD 120 may retrieve the number of received medium access control (MAC) protocol data units (MPDUs) on each of the links 131, 132 and 133 via a link level STA statistic request. The non-AP MLD 110 may reply, via a link level STA statistic report, one MPDU is received on each of the links 131, 132 and 133. Thus, the AP MLD 120 determines that the total number of received MPDUs is three based on the three link level STA statistics reports. However, there is actually only one MPDU (that is, datal) delivered between the two MLDs. In other words, if we only count link level statistics, the three MPDUs are transmitted (which is wrong information). However, if we count MLD level statistics, one MPDU (data1) is transmitted (which is correct information). That is, wrong information will be obtained if the number of received MPDUs is determined based on the counters of the links 131, 132 and 133.

FIG. 2B illustrates another example 205 of difference between link level statistics and delay information and MLD level statistics and delay information. The example 205 may involve the AP MLD 120 and the non-AP MLD 110 as illustrated in FIG. 1B.

As shown in FIG. 2B, the non-AP MLDs 110, 140 and 150 are associated with the AP MLD 120. In other words, there are three non-AP MLDs associated with an AP MLD. The numbers of established links between the AP MLD 120 and the non-AP MLD 110, the non-AP MLD 140 and the non-AP MLD 150 are three, two and one, respectively. The APs 121, 122 and 123 affiliated with the AP MLD 120 may record the number of STAs based on the number of connected STAs.

If we only count link level statistics, there are six STAs connected to the AP MLD 120. However, if we count MLD level statistics, there are actually three non-AP MLDs connected to the AP MLD 120. Obviously, the AP MLD 120 calculates a wrong value based on the information provided by associated STA counter on each of APs 121, 122 and 123.

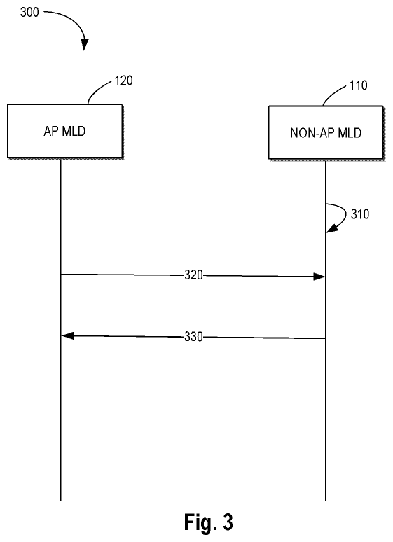

Example embodiments of the present disclosure provide a solution for identification and discovery of a device so as to solve the above problems and one or more of other potential problems. According to the solution, an MLD determines at least one of statistic information associated with the MLD or delay information associated with the MLD. In response to receiving a request for the at least one of the statistic information or the delay information from a second MLD, the MLD transmits the at least one of the statistic information or the delay information to the second MLD. In this way, based on the at least one of the statistic information or the delay information to the MLD, the MLD may make a decision on continuing to connect to the second MLD or connect to a neighbor MLD so as to improve its performance. Hereinafter, principles of the present disclosure will be described with reference to FIGS. 3 to 9.

FIG. 3 illustrates a signaling chart illustrating a process 300 for request and report of at least one of statistic information or delay information associated with an MLD in accordance with some example embodiments of the present disclosure.

The process 300 may involve a first MLD and a second MLD. In some embodiments, each of the first MLD and the second MLD may be implemented as a non-AP MLD, such as two of the non-AP MLDs 110, 140 and 150 as shown in FIGS. 1A, 1B and 1C. In other embodiments, the first MLD may be implemented as a non-AP MLD, such as one of the non-AP MLDs 110, 140 and 150, and the second MLD may be implemented as an AP MLD, such as one of the AP MLDs 120 and 160 as shown in FIGS. 1A, 1B and 1C. Hereinafter, the process 300 will be described with reference to the communication environment 100A of FIG. 1A. However, this process may be likewise applied to other communication scenarios, such as the communication environment 100B or 100C.

As shown in FIG. 3, the non-AP MLD 110 determines 310 at least one of statistic information associated with the non-AP MLD 110 or delay information associated with the non-AP MLD 110.

The AP MLD 120 transmits 320, to the non-AP MLD 110, a request for the at least one of the statistic information or the delay information associated with the non-AP MLD 110.

In some embodiments, the AP MLD 120 may transmit the request for the at least one of the statistic information or the delay information by transmitting a station statistics request frame. In some embodiments, the station statistics request frame may be comprised in a measurement request to be transmitted to the non-AP MLD 110.

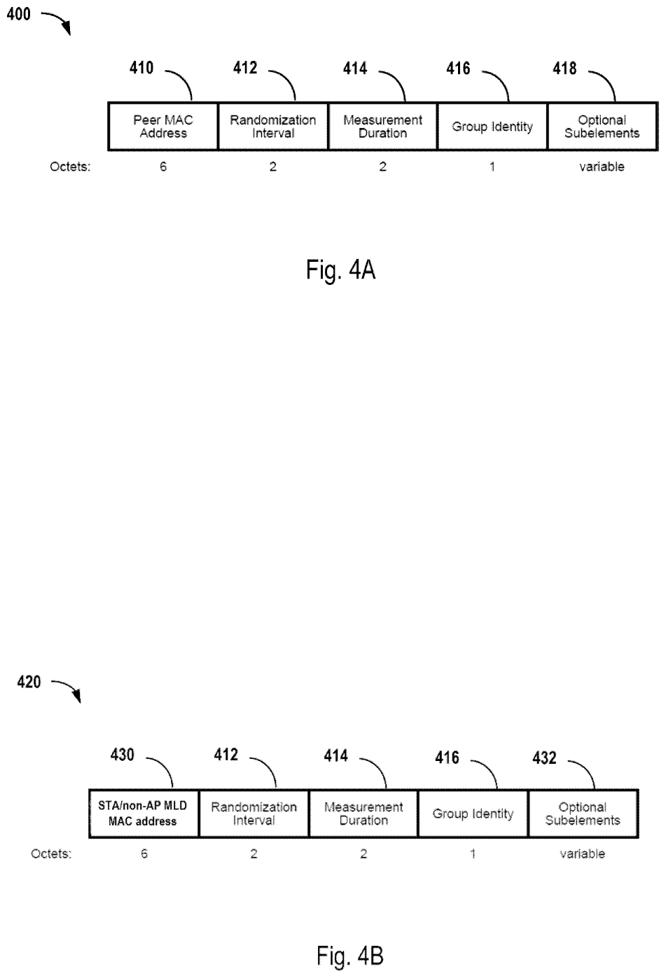

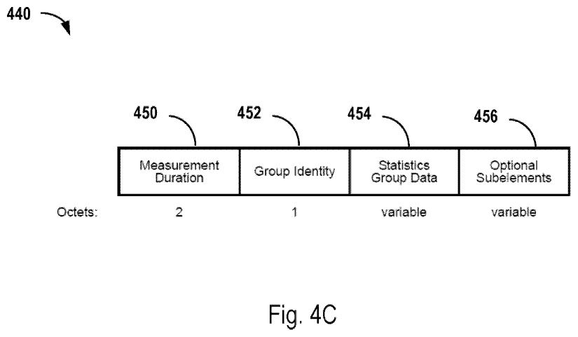

In some embodiments, the station statistics request frame may be transmitted on a specific link among multiple links from the AP MLD 120 to the non-AP MLD 110. In such embodiments, the station statistics request frame may comprise: a first address of a first MAC entity of the non-AP MLD 110 in a first subelement field. Hereinafter, the subelement field may be also referred to as an optional subelements field. The first address indicates to request the at least one of the statistic information and the delay information associated with the non-AP MLD 110. This will be described with reference to FIG. 4A and Table 1.

FIG. 4A illustrates an example of a station statistics request frame 400 in accordance with some example embodiments of the present disclosure. As shown in FIG. 4A, the station statistics request frame 400 comprises a peer MAC address field 410, a randomization interval field 412, a measurement duration field 414, a group identity field 416 and an optional subelements field 418.

Table 1 illustrates an example of values in the optional subelements field 418 in FIG. 4A.

TABLE 1

| Subelement ID | Name | Extensible |
|---|---|---|
| 0 | Reserved | |
| 1 | Trigger Reporting | No |
| 2 | Basic Multi-link | Yes |
| 3-220 | Reserved | |
| 221 | Vendor Specific | Vendor defined |
| 222-255 | Reserved | |

In some embodiments, a reserved Subelement ID in the optional subelements field 418 may indicate to request the at least one of the statistic information or the delay information associated with the non-AP MLD 110. For example, a reserved Subelement ID “2” in line 4, column 1 of Table 1 may indicate to request the at least one of the statistic information or the delay information associated with the non-AP MLD 110. Of course, in other embodiments, one of other reserved Subelement IDs in Table 1 may be used for this purpose.

In addition, as shown in line 4, column 2 of Table 1, a Basic Multi-link element associated with the reserved Subelement ID “2” may be added to carry the first address of the first MAC entity of the non-AP MLD 110.

Alternatively, in some embodiments, the station statistics request frame may be transmitted on any of multiple links between the AP MLD 120 and the non-AP MLD 110. In such embodiments, the station statistics request frame may comprise the first address of the first MAC entity of the non-AP MLD 110. The first address indicates to request the at least one of the statistic information or the delay information associated with the MLD. This will be described with reference to FIG. 4B.

FIG. 4B illustrates another example of a station statistics request frame 420 in accordance with some example embodiments of the present disclosure. As shown in FIG. 4B, the station statistics request frame 420 is similar to the station statistics request frame 400 in that the station statistics request frame 420 also comprises the randomization interval field 412, the measurement duration field 414 and the group identity field 416.

The station statistics request frame 420 is different from the station statistics request frame 400 in an STA/non-AP MLD MAC address field 430. In some embodiments, the STA/non-AP MLD MAC address field 430 may carry the first address of the first MAC entity of the non-AP MLD 110 or an address of an MAC entity of an STA. The first address indicates to request the at least one of the statistic information or the delay information associated with the MLD. The address indicates to request at least one of statistic information or delay information associated with the STA.

In addition, the station statistics request frame 420 is different from the station statistics request frame 400 in an optional subelements field 432. The optional subelements field 432 are not used to indicate to request the at least one of the statistic information or the delay information associated with the MLD.

Returning to FIG. 3, in response to receiving the request for the at least one of the statistic information or the delay information, the non-AP MLD 110 transmits 330 the at least one of the statistic information or the delay information to the AP MLD 120.

With the process 300, based on the at least one of the statistic information or the delay information associated with the AP MLD 120, the non-AP MLD 120 may make a decision on continuing to connect to the current AP MLD 110 or connect to a neighbor AP MLD so as to improve its performance.

In addition, based on the at least one of the statistic information or the delay information associated with the AP MLD 120, the non-AP MLD 110 may make a decision, such as a decision on traffic scheduling and/or load balancing.

In some embodiments, the non-AP MLD 110 may transmit the at least one of the statistic information or the delay information by transmitting a station statistics report frame.

In embodiments where the station statistics request frame is transmitted on a specific link among multiple links between the AP MLD 120 and the non-AP MLD 110, the station statistics report frame may be transmitted on the specific link among multiple links between the AP MLD 120 and the non-AP MLD 110. In such embodiments, the station statistics report frame may comprise at least one of the following: the at least one of the statistic information or the delay information, or a second address of a second MAC entity of the AP MLD 120 in a second optional subelements field. The second address indicates that the at least one of the statistic information or the delay information is associated with the non-AP MLD 110. This will be described with reference to FIG. 4C and Table 2.

FIG. 4C illustrates an example of a station statistics report frame 440 in accordance with some example embodiments of the present disclosure. As shown in FIG. 4C, the station statistics report frame 440 comprises a measurement duration field 450, a group identity field 452, a statistics group data field 454, and an optional subelements field 456. In some embodiments, the statistics group data field 454 may carry the at least one of the statistic information or the delay information associated with the non-AP MLD 110.

Table 2 illustrates an example of values in the optional subelements field 456 in FIG. 4C.

TABLE 2

| Subelement ID | Name | Extensible |
|---|---|---|
| 0 | Reserved | |
| 1 | Reporting Reason | No |
| 2 | Basic Multi-link | Yes |
| 3-220 | Reserved | |
| 221 | Vendor Specific | Vendor defined |
| 222-255 | Reserved | |

In some embodiments, a reserved Subelement ID in the optional subelements field 456 may indicate the at least one of the statistic information or the delay information in the statistics group data field 454 is associated with the non-AP MLD 110. For example, a reserved Subelement ID “2” in line 4, column 1 of Table 2 may indicate the at least one of the statistic information or the delay information in the statistics group data field 454 is associated with the non-AP MLD 110. Of course, in other embodiments, one of other reserved Subelement IDs in Table 2 may be used for this purpose.

In addition, as shown in line 4, column 2 of Table 2, a Basic Multi-link element associated with the reserved Subelement ID “2” may be added to carry the second address of the second MAC entity of the AP MLD 120.

In embodiments where the station statistics request frame is transmitted on any of the multiple links between the AP MLD 120 and the non-AP MLD 110, the station statistics report frame may be transmitted on any of the multiple links between the AP MLD 120 and the non-AP MLD 110.

In some embodiments, the non-AP MLD 110 may be configured with MLD level counters and determine the statistic information associated with the non-AP MLD 110 based on values of the MLD level counters.

In some embodiments, the statistic information associated with the MLD comprise at least one of the following:
a number of fragment frames transmitted by the MLD,
a number of multicast frames transmitted by the MLD,.
a number of frames transmitted failures by the MLD,.
a number of fragment frames received by the MLD,.
a number of frames with frame check sequence error received by the MLD
a number of fragment frames transmitted by the MLD,.
a number of frames retransmitted by the MLD,
a number of frames multiple retransmitted by the MLD,.
a number of frames re-received by the MLD,
a number of requests to send (RTS) successfully transmitted by the MLD,
a number of RTS failed transmitted by the MLD, or
a number of unacknowledged frames transmitted by the MLD.

In some embodiments, the frames comprise a quality of service (QOS) frame having a traffic indicator in a range of 0 to 7, and the statistic information comprises at least one of the following:
a number of QOS fragments transmitted by the MLD,.
a number of QoS transmitted failures by the MLD,.
a number of QoS frames retransmitted by the MLD,
a number of QoS frames multicast retransmitted by the MLD,
a number of QoS frames re-received by the MLD,
a number of QOS RTS transmitted successfully,
a number of QOS RTS transmitted unsuccessfully,
a number of QOS unacknowledged frames transmitted by the MLD,.
a number of QOS fragments received by the MLD,
a number of QoS frames received by the MLD,.
a number of QoS frames discarded by the MLD,
a number of QOS MPDUs received by the MLD, or
a number of QOS retransmitted frames received by the MLD.

In some embodiments, the frames comprises an aggregate medium access control (MAC) service data unit (A-MSDU), and the statistic information comprises at least one of the following:
a number of transmitted A-MSDUs by the MLD,
a number of transmitted A-MSDU failures by the MLD,
a number of transmitted bytes in an A-MSDU by the MLD,
a number of retransmitted A-MSDUs by the MLD,
a number of multiple retransmitted A-MSDUs by the MLD,
a number of unacknowledged A-MSDUs by the MLD,
a number of received A-MSDUs by the MLD, or.
a number of received bytes in an A-MSDU by the MLD.

In some embodiments, the frames comprise an aggregate medium access control (MAC) protocol data unit (A-MPDU), and the statistic information comprises at least one of the following:
a number of A-MPDUs transmitted by the MLD,
a number of MPDUs in an A-MPDU transmitted by the MLD,.
a number of bytes in an A-MPDU transmitted by the MLD,
a number of A-MPDUs received by the MLD,.
a number of MPDUs in an A-MPDU received by the MLD,
a number of bytes in an A-MPDU received by the MLD, or.
a number of A-MPDUs with cyclic redundancy check error received by the MLD.

In some embodiments, the delay information associated with the MLD may comprise at least one of the following:
MLD average access delay,
MLD average delay on a quality of service QoS frame with a priority of best effort,
MLD average delay on the QoS frame with a priority of background,
MLD average delay on the QoS frame with a priority of video,
MLD average delay on the QoS frame with a priority of voice,
Non-AP MLD number, or
MLD channel utilization.

In some embodiments, the non-AP MLD 110 may comprise a first station management entity (SME) and a first medium access control sublayer management entity (MLME). The first SME may communicate with the first MLME using primitive. The primitive is used to describe some abstract behavior, signaling and/or function between an SME and an MLME (or between an SME and a PLME). Any action specified as relating to a service access point (SAP) primitive is to be interpreted as an action on an invocation or instance of that primitive.

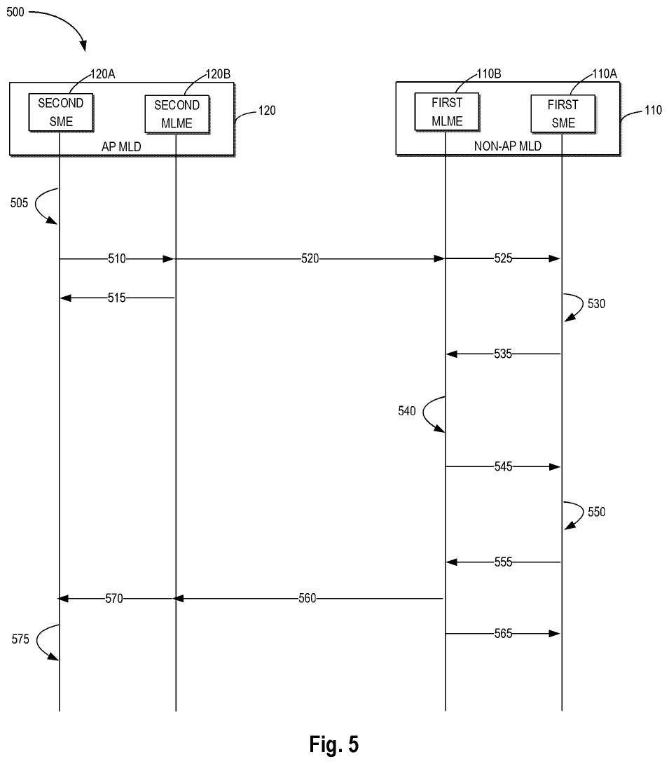

Similarly, the AP MLD 120 may comprise a second SME and a second MLME. The second SME may communicate with the second MLME using primitive. This will be described with reference to FIG. 5.

FIG. 5 illustrates a signaling chart illustrating a process 500 for request and report of at least one of statistic information or delay information associated with an MLD in accordance with some example embodiments of the present disclosure. The process 500 may be considered as an example implementation of the process 300. Hereinafter, the process 500 will be described with reference to the communication environment 100A of FIG. 1A. However, this process may be likewise applied to other communication scenarios, such as the communication environment 100B or 100C.

As shown in FIG. 5, the non-AP MLD 110 comprises a first SME 110A and a first MLME 110B. The AP MLD 120 comprises a second SME 120A and a second MLME 120B.

Upon making 505 a decision to request measurement from the non-AP MLD 110, the second SME 120A provides 510 a second request primitive to the second MLME 120B so as to indicate that a request for the at least one of the statistic information or the delay information is to be transmitted.

As described above, in some embodiments, the AP MLD 120 may transmit the request for the at least one of the statistic information or the delay information by transmitting the station statistics request frame. The station statistics request frame may be comprised in a measurement request to be transmitted to the non-AP MLD 110.

In such embodiments, the station statistics request frame may be transmitted on a specific link among multiple links between the AP MLD 120 and the non-AP MLD 110. In such embodiments, the second request primitive may comprise at least one of the following: the first address of the first MAC entity of the non-AP MLD 110, or a fourth address of a fourth MAC entity of a device affiliated with the non-AP MLD 110. The fourth address indicates that the at least one of the statistic information or the delay information is to be transmitted to the device. For example, the device affiliated with the non-AP MLD 110 may be one of the STAs 111, 112 and 113 as shown in FIG. 1A.

In such embodiments, the second request primitive may comprise an MLME-MREQUEST.request primitive. An example of the MLME-MREQUEST.request primitive is shown as below:

```
MLME-MREQUEST.request (
  STA MAC Address,
  Dialog Token,
  Measurement Request Set,
  Number of Repetitions,
  Measurement Category,
  VendorSpecificInfo,
  MLD MAC address
  )
```

Table 3 illustrates details of parameters in the MLME-MREQUEST.request primitive.

TABLE 3

| Name | Type | Valid range | Description |
|---|---|---|---|
| STA MAC Address | MAC address | Any valid individual | The address of the peer MAC |
| | | or group MAC | entity to which the measurement |
| | | address | request is transmitted. |
| Dialog Token | Integer | 1-255 | The dialog token to identify the |
| | | | measurement transaction. |
| Measurement | Set of | Set of measurement | A set of measurement requests, each |
| Request Set | measurement | requests | containing a measurement token, |
| | requests, each | | measurement request mode, |
| | as defined in the | | measurement type, and measurement |
| | Measurement | | request. |
| | Request | | |
| | element format | | |
| Number of | Integer | 0-65535 | The number of times the |
| Repetitions | | | Measurement Request Set is to be |
| | | | repeated. The parameter is present if |
| | | | Measurement Category is Radio |
| | | | Measurement and |
| | | | dot11RadioMeasurementActivated is |
| | | | true; otherwise not present. |
| Measurement | Enumeration | SPECTRUM | Indicate whether the contents of the |
| Category | | MANAGEMENT, or | Measurement Report Set parameter is |
| | | RADIO | a set of Spectrum Management |
| | | MEASUREMENT | requests or a set of Radio |
| | | | Measurement requests. |
| | | | The parameter is present if |
| | | | dot11RadioMeasurementActivated is |
| | | | true; otherwise not present. |
| VendorSpecificInfo | A set of | Vendor Specific | Zero or more elements. |
| | elements | element | |
| MLD MAC | MAC address | Any valid individual | The address of the MAC entity of |
| Address | | or group MAC | the MLD to which the |
| | | address | measurement request is |
| | | | transmitted. |

As shown in Table 3, the “STA MAC Address” is the address of the peer MAC entity to which the measurement request is transmitted. In other words, the “STA MAC Address” is the address of the peer MAC entity to which the request for the at least one of the statistic information or the delay information associated with the non-AP MLD 110 is transmitted. For example, in case where the request is transmitted to the STA 111 affiliated with the non-AP MLD 110, the “STA MAC Address” is the address of the MAC entity of the STA 111.

In addition, as shown in Table 3, the “MLD MAC Address” is the address of the MAC entity of the MLD to which the measurement request is transmitted. For example, the “MLD MAC Address” may be the address of the MAC entity of the non-AP MLD 110 to which the request for the at least one of the statistic information or the delay information associated with the non-AP MLD 110 is transmitted.

With continued reference to FIG. 5, upon receiving the second request primitive from the second SME 120A provides 510, the second MLME 120B provides 515 a confirmation to the second SME 120A so as to indicate that the second request primitive was received. In addition, the second MLME 120B transmits 520 a measurement request to the first MLME 110B of the non-AP MLD 110. The measurement request comprises the request for the at least one of the statistic information or the delay information associated with the non-AP MLD 110.

Upon receiving the request for the at least one of the statistic information or the delay information associated with the non-AP MLD 110, the first MLME 110B provides 525 a first indication to the first SME 110A so as to indicate that the request for the at least one of the statistic information or the delay information was received.

In some embodiments, the first indication primitive may comprise at least one of the following: the second address of the second MAC entity of the AP MLD 120, or a third address of a third MAC entity of a device affiliated with the AP MLD 120. The third address indicates that the at least one of the statistic information or the delay information is to be received via the device. For example, the device affiliated with the AP MLD 120 may be one of the AP 121, 122 and 123 as shown in FIG. 1A.

In such embodiments, the first indication primitive may comprise an MLME-MREQUEST.indication primitive. An example of the MLME-MREQUEST.indication primitive is shown as below:

```
MLME-MREQUEST.indication (
  STA MAC Address,
  Dialog Token,
  Measurement Request Set,
  Number of Repetitions,
  Measurement Category,
  VendorSpecificInfo,
  MLD MAC address
  )
```

Table 4 illustrates details of parameters in the MLME-MREQUEST.indication primitive.

TABLE 4

| Name | Type | Valid range | Description |
|---|---|---|---|
| STA MAC Address | MAC address | Any valid individual | The address of the peer MAC |
| | | MAC address | entity from which the measurement |
| | | | request was received. |
| Dialog Token | Integer | 1-255 | The dialog token to identify the |
| | | | measurement transaction. |
| Measurement | Set of | Set of measurement | A set of measurement requests, each |
| Request Set | measurement | requests | containing a Measurement Token, |
| | requests, each | | Measurement Request Mode, |
| | as defined in the | | Measurement Type, and |
| | Measurement | | Measurement Request. |
| | Request | | |
| | element format | | |
| Number of | Integer | 0-65535 | The number of times the |
| Repetitions | | | Measurement Request Set is to be |
| | | | repeated. The parameter is present if |
| | | | Measurement Category is Radio |
| | | | Measurement and |
| | | | dot11RadioMeasurementActivated is |
| | | | true; otherwise not present. |
| Measurement | Enumeration | SPECTRUM | Indicate whether the contents of the |
| Category | | MANAGEMENT, or | Measurement Report Set parameter is |
| | | RADIO | a set of Spectrum Management |
| | | MEASUREMENT | requests or a set of Radio |
| | | | Measurement requests. |
| | | | The parameter is present if |
| | | | dot11RadioMeasurementActivated is |
| | | | true; otherwise not present. |
| VendorSpecificInfo | A set of | Vendor | Zero or more elements. |
| | elements | Specific element | |
| MLD MAC | MAC address | Any valid individual | The address of the MAC entity of |
| Address | | or group MAC | the MLD from which the |
| | | address | measurement request is received. |

As shown in Table 4, the “STA MAC Address” is the address of the peer MAC entity from which the measurement request was received. In other words, the “STA MAC Address” is the address of the peer MAC entity from which the request for the at least one of the statistic information or the delay information associated with the non-AP MLD 110 is received. For example, in case where the request is received from the AP 121 affiliated with the AP MLD 120, the “STA MAC Address” is the address of the MAC entity of the AP 121.

In addition, as shown in Table 4, the “MLD MAC Address” is the address of the MAC entity of the MLD from which the measurement request is received. For example, the “MLD MAC Address” may be the address of the MAC entity of the AP MLD 120 from which the request for the at least one of the statistic information or the delay information associated with the non-AP MLD 110 is received.

With continued reference to FIG. 5, upon receiving the first indication from the first MLME 110B, the first SME 110A makes 530 a decision to accept the measurement request from the AP MLD 120. In turn, the first SME 110A provides 535 a measurement request primitive to the first MLME 110B. For example, the measurement request primitive may comprise MLME-MEASURE.request primitive.

Upon receiving the measurement request primitive from the first SME 110A, the first MLME 110B performs 540 a measurement process. Upon finishing the measurement process, the first MLME 110B provides 545 a confirmation to the first SME 110A so as to indicate the measurement process was finished.

Upon receiving the confirmation from the first MLME 110B, the first SME 110A compiles 550 a measurement report. In turn, the first SME 110A provides 555 a first request primitive to the first MLME 110B.

In embodiments where the station statistics report frame is transmitted on a specific link among multiple links between the AP MLD 120 and the non-AP MLD 110, the first request primitive may comprise at least one of the following: the at least one of the statistic information or the delay information, an address of a MAC entity of a device affiliated with the AP MLD 120, or the second address of the second MAC entity of the AP MLD 120. The address of the MAC entity of the device indicates that the at least one of the statistic information or the delay information is to be transmitted to the device. For example, the device affiliated with the AP MLD 120 may be one of the APs 121, 122 and 123 as shown in FIG. 1A.

In such embodiments, the first request primitive may comprise an MLME-MREPORT.request primitive. An example of the MLME-MREPORT.request primitive is shown as below:

```
MLME-MREPORT.request (
  STA MAC Address,
  Dialog Token,
  Measurement Request Set,
  Measurement Category,
  VendorSpecificInfo,
  MLD MAC address
  )
```

Table 5 illustrates details of parameters in the MLME-MREPORT.request primitive.

TABLE 5

| Name | Type | Valid range | Description |
|---|---|---|---|
| STA MAC Address | MAC address | Any valid individual | The address of the peer MAC |
| | | MAC address | entity to which the measurement |
| | | | report is sent. |
| Dialog Token | Integer | 0-255 | The dialog token to identify the |
| | | | measurement transaction. Set to 0 for |
| | | | an autonomous report. |
| Measurement | Set of | Set of measurement | A set of measurement reports, each |
| Report Set | measurement | reports | containing a Measurement Token, |
| | reports, each as | | Measurement Report Mode, |
| | defined in the | | Measurement Type, and |
| | Measurement | | Measurement Report. |
| | Report element | | |
| | format | | |
| Measurement | Enumeration | SPECTRUM | Indicate whether the Measurement |
| Category | | MANAGEMENT, or | Report Set is a set of Spectrum |
| | | RADIO | Management or Radio Measurement |
| | | MEASUREMENT | reports. The parameter is present if |
| | | | dot11RadioMeasurementActivated is |
| | | | true; otherwise not present. |
| VendorSpecificInfo | A set of | Vendor Specific | Zero or more elements. |
| | elements | element | |
| MLD MAC | MAC address | Any valid individual | The address of the MAC entity of |
| Address | | or group MAC | the MLD to which the |
| | | address | measurement report is sent. |

As shown in Table 5, the “STA MAC Address” is the address of the peer MAC entity to which the measurement report is transmitted. In other words, the “STA MAC Address” is the address of the peer MAC entity to which the at least one of the statistic information or the delay information associated with the non-AP MLD 110 is transmitted. For example, in case where the at least one of the statistic information or the delay information is transmitted to the AP 121 affiliated with the AP MLD 120, the “STA MAC Address” is the address of the MAC entity of the AP 121.

In addition, as shown in Table 5, the “MLD MAC Address” is the address of the MAC entity of the MLD to which the measurement report is transmitted. For example, the “MLD MAC Address” may be the address of the MAC entity of the AP MLD 120 to which the at least one of the statistic information or the delay information associated with the non-AP MLD 110 is transmitted.

With continued reference to FIG. 5, upon receiving the first request primitive from the first SME 110A, the first MLME 110B transmits 560 a measurement report to the second MLME 120B of the AP MLD 120. The measurement report comprises the at least one of the statistic information or the delay information associated with the non-AP MLD 110. In addition, the first MLME 110B provides 565 a confirmation to the first SME 110A so as to indicate the first request primitive is received.

Upon receiving the measurement report comprising the at least one of the statistic information or the delay information associated with the non-AP MLD 110, the second MLME 120B provides 570 a second indication primitive to the second SME 120A so as to indicate the at least one of the statistic information or the delay information was received.

In some embodiments, the second indication primitive may comprise at least one of the following: the at least one of the statistic information or the delay information, the first address of the first MAC entity of the non-AP MLD 110, or the fourth address of the fourth MAC entity of the device affiliated with the non-AP MLD 110. The fourth address indicates that the at least one of the statistic information or the delay information is received from the device. For example, the device affiliated with the non-AP MLD 110 may be one of the STAs 111, 112 and 113 as shown in FIG. 1A.

In such embodiments, the second indication primitive may comprise an MLME-MREPORT.indication primitive. An example of the MLME-MREPORT.indication primitive is shown as below:

```
MLME-MREPORT.indication primitive (
  STA MAC Address,
  Dialog Token,
  Measurement Request Set,
  Measurement Category,
  VendorSpecificInfo,
  MLD MAC address
  )
```

Table 6 illustrates details of parameters in the MLME-MREPORT.indication primitive.

TABLE 6

| Name | Type | Valid range | Description |
|---|---|---|---|
| STA MAC Address | MAC address | Any valid individual | The address of the peer MAC |
| | | MAC address | entity from which the measurement |
| | | | report was received. |
| Dialog Token | Integer | 0-255 | The dialog token to identify the |
| | | | measurement transaction. Set to 0 for |
| | | | an autonomous report. |
| Measurement | Set of | Set of measurement | A set of measurement reports, each |
| Report Set | measurement | reports | containing a Measurement Token, |
| | reports, each as | | Measurement Report Mode, |
| | defined in the | | Measurement Type, and |
| | Measurement | | Measurement Report. |
| | Report element | | |
| | format | | |
| Measurement | Enumeration | SPECTRUM | Indicates whether the Measurement |
| Category | | MANAGEMENT, or | Report Set is a set of Spectrum |
| | | RADIO | Management or Radio Measurement |
| | | MEASUREMENT | reports. The parameter is present if |
| | | | dot11RadioMeasurementActivated is |
| | | | true; otherwise not present. |
| VendorSpecificInfo | A set of | Vendor Specific | Zero or more elements. |
| | elements | element | |
| MLD MAC | MAC address | Any valid individual | The address of the MAC entity of |
| Address | | or group MAC | the MLD from which the |
| | | address | measurement report was received. |

As shown in Table 6, the “STA MAC Address” is the address of the peer MAC entity from which the measurement report was received. In other words, the “STA MAC Address” is the address of the peer MAC entity from which the at least one of the statistic information or the delay information associated with the non-AP MLD 110 was received. For example, in case where the at least one of the statistic information or the delay information is received from the STA 111 affiliated with the non-AP MLD 110, the “STA MAC Address” is the address of the MAC entity of the STA 111.

In addition, as shown in Table 6, the “MLD MAC Address” is the address of the MAC entity of the MLD from which the measurement report was received. For example, the “MLD MAC Address” may be the address of the MAC entity of the non-AP MLD 110 from which the at least one of the statistic information or the delay information associated with the non-AP MLD 110 was received.

With continued reference to FIG. 5, upon receiving the second indication primitive from the second MLME 120B, the second SME 120A determines 575 that the measurement request is completed.

As described above, in some embodiments, the station statistics request frame may be transmitted on any of the multiple links between the AP MLD 120 and the non-AP MLD 110. In such embodiments, the second request primitive provided from the second SME 120A to the second MLME 120B may comprise the first address of the first MAC entity of the non-AP MLD 110. The first address indicates that the at least one of the statistic information or the delay information is to be transmitted to any of devices affiliated with the non-AP MLD 110.

In such embodiments, the second request primitive may comprise an MLME-MREQUEST.request primitive. An example of the MLME-MREQUEST.request primitive is shown as below:

```
MLME-MREQUEST.request (
  STA/MLD MAC Address,
  Dialog Token,
  Measurement Request Set,
  Number of Repetitions,
  Measurement Category,
  VendorSpecificInfo
  )
```

In the above MLME-MREQUEST.request primitive, for example, the parameter “STA/MLD MAC Address” may be the first address of the first MAC entity of the non-AP MLD 110 or an address of an MAC entity of an STA affiliated with the non-AP MLD 110. The first address indicates to request the at least one of the statistic information or the delay information associated with the non-AP MLD 110. The address of the MAC entity of the STA indicates to request at least one of statistic information or delay information associated with the STA.

In embodiments where the station statistics request frame is transmitted on any of the multiple links between the AP MLD 120 and the non-AP MLD 110, the first indication primitive provided from the first MLME 110B to the first SME 110A may comprise the second address of the second MAC entity of the AP MLD 120. The second address indicates that the at least one of the statistic information or the delay information is to be received via any of devices affiliated with the AP MLD 120.

As described above, in some embodiments, the station statistics report frame may be transmitted on any of the multiple links between the AP MLD 120 and the non-AP MLD 110. In such embodiments, the first request primitive provided from the first SME 110A to the first MLME 110B may comprise at least one of the following: the at least one of the statistic information or the delay information, or the second address of the second MAC entity of the AP MLD 120. The second address indicates that the at least one of the statistic information and the delay information is to be transmitted to any of devices affiliated with the AP MLD 120.

In embodiments where the station statistics report frame is transmitted on any of the multiple links between the AP MLD 120 and the non-AP MLD 110, the second indication primitive provided from the second MLME 120B to the second SME 120A may comprise at least one of the following: the at least one of the statistic information or the delay information, or the first address of the first MAC entity of the non-AP MLD 110. The first address indicates that the at least one of the statistic information and the delay information is received from any of devices affiliated with the non-AP MLD 110.

In some embodiments, the AP MLD 120 may transmit, to the non-AP MLD 110, the request for the at least one of the statistic information or the delay information in response to receiving, from an AC device, a query request for the at least one of the statistic information or the delay information. In such embodiments, upon receiving the at least one of the statistic information or the delay information, the AP MLD 120 may transmit, to the AC device, the at least one of the statistic information or the delay information. This will be described with reference to FIG. 1C.

The AC device 170 may transmit, to the AP MLD 120, a query request for at least one of statistic information or delay information associated with the AP MLD 120, at least one of statistic information or delay information associated with the non-AP MLD 110 as well as at least one of statistic information or delay information associated with the non-AP MLD 150 periodically by an API defined by data element specification or in response to a condition being met.

In some embodiments, the at least one of statistic information or delay information associated with the AP MLD 120 may comprise at least one of the following: the number of non-AP MLDs associated with the AP MLD 120, packets sent, packet received, error sent, error received, retransmitted counter of the AP MLD 120.

In some embodiments, the at least one of statistic information or delay information associated with the non-AP MLD 110 or 150 may comprise at least one of the following: packets sent, packet received, error sent, error received, retransmitted counter of the non-AP MLD 110 or 150.

In some embodiments, the condition may comprise TP, latency, or the number of non-AP MLDs being above a first threshold determined by the AC device 170. For example, if the number of non-AP MLDs associated with the AP MLD 120 is above the first threshold, the AC device 170 may transmit the query request to the AP MLD 120.

Upon receiving the query request from the AC device 170, the AP MLD 120 may transmit, to the non-AP MLD 150, a request for the at least one of the statistic information or the delay information associated with the non-AP MLD 150.

Upon receiving the request for the at least one of the statistic information or the delay information associated with the non-AP MLD 150, the non-AP MLD 150 may transmit, to the AP MLD 120, the at least one of the statistic information or the delay information associated with the non-AP MLD 150.

In some embodiments, the at least one of the statistic information or the delay information associated with the non-AP MLD 150 may comprise at least one of the following: QoS retry count, QoS frame duplicated count, QoS discarded frame count, or QOS MPDUs received count.

Upon receiving the at least one of the statistic information or the delay information associated with the non-AP MLD 150, the AP MLD 120 may transmit, to the AC device 170, the at least one of the statistic information or the delay information associated with the non-AP MLD 150.

Upon receiving the at least one of the statistic information or the delay information associated with the non-AP MLD 150, the AC device 170 may determine whether to move the non-AP MLD 150 to a neighbor AP MLD, such as the AP MLD 160.

For example, if at least one of the following is met on at least one of the sides of the AP MLD 120 and the non-AP MLD 150, the AC device 170 determines to move the non-AP MLD 150 to the AP MLD 160:
the ratio of the number of retransmitted frames to the total number of frames being above a second threshold,.
the ratio of the number of dropped frames to the total number of frames being above a third threshold,.
the ratio of the number of duplicated frames to the total number of frames being above a fourth threshold, or.
the number of non-AP MLDs associated with the AP MLD 120 being above a fifth threshold.

Upon moving the non-AP MLD 150 from the AP MLD 120 to the AP MLD 160, the AC device 170 may reschedule the downlink or uplink traffic of the non-AP MLD 150 from the AP MLD 120 to the AP MLD 160.

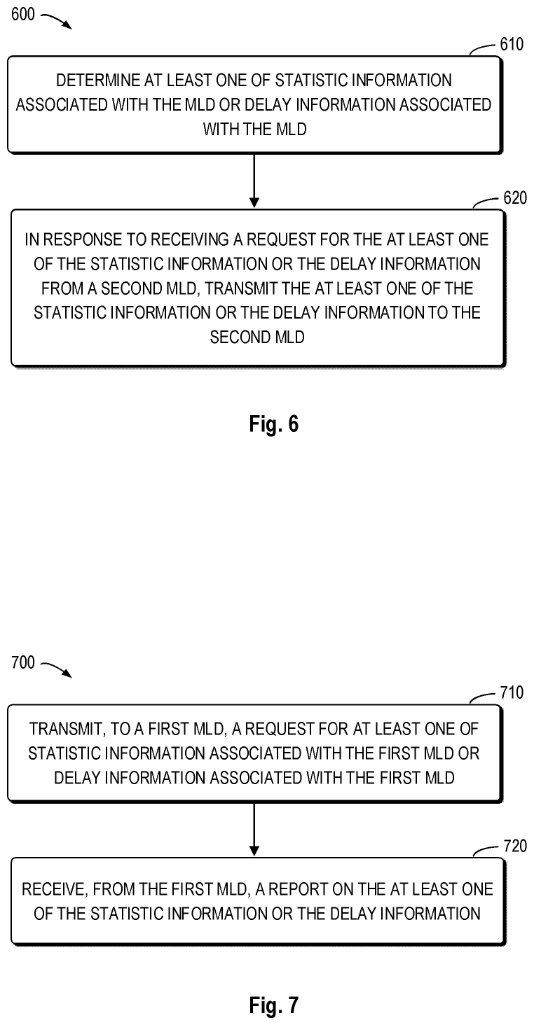

FIG. 6 shows a flowchart of an example method 600 implemented at a first MLD in accordance with some example embodiments of the present disclosure. For example, the first MLD may comprise an AP MLD, such as the AP MLD 120 in FIGS. 1A, 1B and 1C or the AP MLD 160 in FIG. 1C.

At block 610, the first MLD determines at least one of statistic information associated with the first MLD or delay information associated with the first MLD.

At block 620, in response to receiving a request for the at least one of the statistic information or the delay information from a second MLD, the first MLD transmits the at least one of the statistic information or the delay information to the second MLD. For example, the second MLD may comprise a non-AP MLD, such as the non-AP MLD 110 in FIG. 1A, the non-AP MLD 110, 140 or 150 in FIG. 1B, or the non-AP MLD 110 or 150 in FIG. 1C.

In some embodiments, the first MLD may receive the request for the at least one of the statistic information or the delay information by receiving a station statistics request frame from the second MLD.

In some embodiments, the station statistics request frame comprises: a first address of a first medium access control, MAC, entity of the MLD in a first optional subelements field, the first address indicating to request the at least one of the statistic information and the delay information associated with the MLD.

In some embodiments, the first MLD may transmit a station statistics report frame, and the station statistics report frame comprises at least one of the following: the at least one of the statistic information or the delay information, or a first address of a first MAC entity of the first MLD or a second address of a second MAC entity of the second MLD in a second optional subelements field. The first address or the second address indicates that the at least one of the statistic information or the delay information is associated with the first MLD.

In some embodiments, the station statistics request frame comprises: a first address of a first MAC entity of the first MLD, the first address indicating to request the at least one of the statistic information or the delay information associated with the first MLD.

In some embodiments, the first MLD comprises a first SME and a first MLME. In some embodiments, the first MLME is configured to provide a first indication primitive to the first SME so as to indicate that the request for the at least one of the statistic information or the delay information was received.

In some embodiments, the first indication primitive comprises at least one of the following: a second address of a second MAC entity of the second MLD, or a third address of a third MAC entity of a device affiliated with the second MLD, the third address indicating that the at least one of the statistic information or the delay information is to be received via the device.

In some embodiments, the first indication primitive comprises: a second address of a second MAC entity of the second MLD, the second address indicating that the at least one of the statistic information or the delay information is to be received via any of devices affiliated with the second MLD.

In some embodiments, the first SME may be configured to provide a first request primitive to the first MLME, and the first request primitive comprises at least one of the following: the at least one of the statistic information or the delay information, a third address of a third MAC entity of a device affiliated with the second MLD, the third address indicating that the at least one of the statistic information or the delay information is to be transmitted to the device, or a second address of a second MAC entity of the second MLD.

In some embodiments, the first SME may be configured to provide a first request primitive to the first MLME, and the first request primitive comprises at least one of the following: the at least one of the statistic information or the delay information, or a second address of a second MAC entity of the second MLD, the second address indicating that the at least one of the statistic information and the delay information is to be transmitted to any of devices affiliated with the second MLD.

In some embodiments, the statistic information associated with the MLD comprises at least one of the following:
a number of fragment frames transmitted by the MLD,
a number of multicast frames transmitted by the MLD,.
a number of frames transmitted failures by the MLD,.
a number of fragment frames received by the MLD,.
a number of frames with frame check sequence error received by the MLD
a number of fragment frames transmitted by the MLD,
a number of frames retransmitted by the MLD,
a number of frames multiple retransmitted by the MLD,.
a number of frames re-received by the MLD,
a number of requests to send (RTS) successfully transmitted by the MLD,.
a number of RTS failed transmitted by the MLD, or
a number of unacknowledged frames transmitted by the MLD.

In some embodiments, the frames comprise a quality of service (QOS) frame having a traffic indicator in a range of 0 to 7, and the statistic information comprises at least one of the following:
a number of QoS fragments transmitted by the MLD,.
a number of QoS transmitted failures by the MLD,.
a number of QoS frames retransmitted by the MLD,
a number of QoS frames multicast retransmitted by the MLD,.
a number of QoS frames re-received by the MLD,
a number of QOS RTS transmitted successfully,
a number of QOS RTS transmitted unsuccessfully,
a number of QOS unacknowledged frames transmitted by the MLD,
a number of QoS fragments received by the MLD,.
a number of QoS frames received by the MLD,
a number of QoS frames discarded by the MLD,
a number of QOS MPDUs received by the MLD, or
a number of QoS retransmitted frames received by the MLD.

In some embodiments, the frames comprises an aggregate medium access control (MAC) service data unit (A-MSDU), and the statistic information comprises at least one of the following:
a number of transmitted A-MSDUs by the MLD,.
a number of transmitted A-MSDU failures by the MLD,
a number of transmitted bytes in an A-MSDU by the MLD,
a number of retransmitted A-MSDUs by the MLD,
a number of multiple retransmitted A-MSDUs by the MLD,
a number of unacknowledged A-MSDUs by the MLD,.
a number of received A-MSDUs by the MLD, or
a number of received bytes in an A-MSDU by the MLD.

In some embodiments, the frames comprise an aggregate medium access control (MAC) protocol data unit (A-MPDU), and the statistic information comprises at least one of the following:
a number of A-MPDUs transmitted by the MLD,.
a number of MPDUs in an A-MPDU transmitted by the MLD,
a number of bytes in an A-MPDU transmitted by the MLD,.
a number of A-MPDUs received by the MLD,
a number of MPDUs in an A-MPDU received by the MLD,
a number of bytes in an A-MPDU received by the MLD, or.
a number of A-MPDUs with cyclic redundancy check error received by the MLD.

In some embodiments, the delay information associated with the MLD may comprise at least one of the following:
MLD average access delay,
MLD average delay on a quality of service QoS frame with a priority of best effort,
MLD average delay on the QoS frame with a priority of background,
MLD average delay on the QoS frame with a priority of video,.
MLD average delay on the QOS frame with a priority of voice,
Non-AP MLD number, or
MLD channel utilization.

FIG. 7 shows a flowchart of an example method 700 implemented at a second MLD in accordance with some example embodiments of the present disclosure. For example, the second MLD may comprise an AP MLD, such as the AP MLD 120 in FIGS. 1A and 1B, or one of the AP MLDs 120 and 160 in FIG. 1C.

At block 710, the second MLD transmits, to a first MLD, a request for at least one of statistic information associated with the first MLD or delay information associated with the first MLD.

At block 720, the second MLD receives, from the first MLD, a report on the at least one of the statistic information or the delay information.

In some embodiments, the second MLD may transmit the request for the at least one of the statistic information or the delay information by transmitting a station statistics request frame to the first MLD.

In some embodiments, the station statistics request frame comprises: a first address of a first MAC entity of the first MLD in a first optional subelements field, the first address indicating to request the at least one of the statistic information and the delay information associated with the first MLD.

In some embodiments, the second MLD may receive a station statistics report frame, and the station statistics report frame comprises at least one of the following: the at least one of the statistic information or the delay information, or a first address of a first MAC entity of the first MLD or a second address of a second MAC entity of the second MLD in a second optional subelements field. The first address or the second address indicates that the at least one of the statistic information or the delay information is associated with the first MLD.

In some embodiments, the station statistics request frame comprises at least one of the following: a first address of a first MAC entity of the first MLD, the first address indicating to request the at least one of the statistic information or the delay information associated with the second MLD.

In some embodiments, the second MLD comprises a second SME and a second MLME. In some embodiments, the second SME may provide a second request primitive to the second MLME so as to indicate that the request for the at least one of the statistic information or the delay information is to be transmitted.

In some embodiments, the second request primitive comprises at least one of the following: a first address of a first MAC entity of the first MLD, or a fourth address of a fourth MAC entity of a device affiliated with the first MLD, the fourth address indicating that the at least one of the statistic information or the delay information is to be transmitted to the device.

In some embodiments, the second request primitive comprises: a first address of a first MAC entity of the first MLD, the first address indicating that the at least one of the statistic information or the delay information is to be transmitted to any of devices affiliated with the first MLD.

In some embodiments, the second MLME is configured to provide a second indication primitive to the second SME so as to indicate the at least one of the statistic information or the delay information was received.

In some embodiments, the second indication primitive further comprises at least one of the following: the at least one of the statistic information or the delay information, a first address of a first MAC entity of the first MLD, or a fourth address of a fourth MAC entity of a device affiliated with the first MLD, the fourth address indicating that the at least one of the statistic information or the delay information is received from the device.

In some embodiments, the second indication primitive further comprises at least one of the following: the at least one of the statistic information or the delay information, a first address of a first MAC entity of the first MLD, the first address indicating that the at least one of the statistic information and the delay information is received from any of devices affiliated with the first MLD.

In some embodiments, the statistic information associated with the MLD comprises at least one of the following:
a number of fragment frames transmitted by the MLD,.
a number of multicast frames transmitted by the MLD,
a number of frames transmitted failures by the MLD,.
a number of fragment frames received by the MLD,.
a number of frames with frame check sequence error received by the MLD.
a number of fragment frames transmitted by the MLD,.
a number of frames retransmitted by the MLD,
a number of frames multiple retransmitted by the MLD,
a number of frames re-received by the MLD,
a number of requests to send (RTS) successfully transmitted by the MLD,
a number of RTS failed transmitted by the MLD, or
a number of unacknowledged frames transmitted by the MLD.

In some embodiments, the frames comprise a quality of service (QOS) frame having a traffic indicator in a range of 0 to 7, and the statistic information comprises at least one of the following:
a number of QoS fragments transmitted by the MLD,
a number of QOS transmitted failures by the MLD,
a number of QoS frames retransmitted by the MLD,.
a number of QoS frames multicast retransmitted by the MLD,.
a number of QoS frames re-received by the MLD,
a number of QOS RTS transmitted successfully,
a number of QOS RTS transmitted unsuccessfully,
a number of QOS unacknowledged frames transmitted by the MLD,
a number of QOS fragments received by the MLD,.
a number of QoS frames received by the MLD,.
a number of QoS frames discarded by the MLD,
a number of QOS MPDUs received by the MLD, or
a number of QOS retransmitted frames received by the MLD.

In some embodiments, the frames comprises an aggregate medium access control (MAC) service data unit (A-MSDU), and the statistic information comprises at least one of the following:
a number of transmitted A-MSDUs by the MLD,
a number of transmitted A-MSDU failures by the MLD,
a number of transmitted bytes in an A-MSDU by the MLD,
a number of retransmitted A-MSDUs by the MLD,
a number of multiple retransmitted A-MSDUs by the MLD,.
a number of unacknowledged A-MSDUs by the MLD,.
a number of received A-MSDUs by the MLD, or
a number of received bytes in an A-MSDU by the MLD.

In some embodiments, the frames comprise an aggregate medium access control (MAC) protocol data unit (A-MPDU), and the statistic information comprises at least one of the following:
a number of A-MPDUs transmitted by the MLD,.
a number of MPDUs in an A-MPDU transmitted by the MLD,
a number of bytes in an A-MPDU transmitted by the MLD,
a number of A-MPDUs received by the MLD,.
a number of MPDUs in an A-MPDU received by the MLD,
a number of bytes in an A-MPDU received by the MLD, or.
a number of A-MPDUs with cyclic redundancy check error received by the MLD.

In some embodiments, the delay information associated with the MLD may comprise at least one of the following:
MLD average access delay,
MLD average delay on a quality of service QOS frame with a priority of best effort,
MLD average delay on the QoS frame with a priority of background,
MLD average delay on the QoS frame with a priority of video,
MLD average delay on the QoS frame with a priority of voice,
Non-AP MLD number, or
MLD channel utilization.

In some embodiments, the second MLD is configured to transmit the request for the at least one of the statistic information or the delay information in response to receiving, from an access control device, a query request for the at least one of the statistic information or the delay information associated with the second MLD.

In some embodiments, the second MLD is configured to transmit, to the access control device, the at least one of the statistic information or the delay information associated with the second MLD.

The example embodiments of the present disclosure which have been described with reference to FIGS. 1 to 5 may be also applied to the methods 600 and 700. Thus, the details of the example embodiments are omitted.

In some example embodiments, an apparatus capable of performing the method 600 may comprise means for performing the respective steps of the method 600. The means may be implemented in any suitable form. For example, the means may be implemented in a circuitry or software module or a combination thereof.

In some example embodiments, an apparatus comprises a first MLD. The first MLD has: means for determining at least one of statistic information associated with the first MLD or delay information associated with the first MLD; and means for transmitting the at least one of the statistic information or the delay information to a second MLD in response to receiving a request for the at least one of the statistic information or the delay information from the second MLD.

In some embodiments, the first MLD is configured to receive the request for the at least one of the statistic information or the delay information by receiving a station statistics request frame from the second MLD.

In some embodiments, the station statistics request frame comprises: a first address of a first MAC of the first MLD in a first subelement field, the first address indicating to request the at least one of the statistic information and the delay information associated with the first MLD.

In some embodiments, the first MLD is configured to transmit a station statistics report frame, and the station statistics report frame comprises at least one of the following: the at least one of the statistic information or the delay information, or a first address of a first MAC of the first MLD or a second address of a second MAC entity of the second MLD in a second subelement field, the first address or the second address indicating that the at least one of the statistic information or the delay information is associated with the first MLD.

In some embodiments, the station statistics request frame comprises: a first address of a first MAC of the first MLD, the first address indicating to request the at least one of the statistic information or the delay information associated with the first MLD.

In some embodiments, the first MLD comprises a first station management entity, SME, and a first MLME. In some embodiments, the first MLME is configured to provide a first indication primitive to the first SME so as to indicate that the request for the at least one of the statistic information or the delay information was received.

In some embodiments, the first indication primitive comprises at least one of the following: a second address of a second MAC of the second MLD, or a third address of a third MAC entity of a device affiliated with the second MLD, the third address indicating that the at least one of the statistic information or the delay information is to be received via the device.

In some embodiments, the first indication primitive comprises: a second address of a second MAC of the second MLD, the second address indicating that the at least one of the statistic information or the delay information is to be received via any of devices affiliated with the second MLD.

In some embodiments, the first SME is configured to provide a first request primitive to the first MLME, and the first request primitive comprises at least one of the following: the at least one of the statistic information or the delay information, a third address of a third MAC entity of a device affiliated with the second MLD, the third address indicating that the at least one of the statistic information or the delay information is to be transmitted to the device, or a second address of a second MAC of the second MLD.

In some embodiments, the first SME is configured to provide a first request primitive to the first MLME, and the first request primitive comprises at least one of the following: the at least one of the statistic information or the delay information, or a second address of a second MAC of the second MLD, the second address indicating that the at least one of the statistic information and the delay information is to be transmitted to any of devices affiliated with the second MLD.

In some embodiments, the statistic information comprises at least one of the following:
a number of fragment frames transmitted by the first MLD,
a number of multicast frames transmitted by the first MLD,
a number of frames transmitted failures by the first MLD,
a number of fragment frames received by the first MLD,.
a number of frames with frame check sequence error received by the first MLD
a number of fragment frames transmitted by the first MLD,
a number of frames retransmitted by the first MLD,
a number of frames multiple retransmitted by the first MLD,.
a number of frames re-received by the first MLD,
a number of requests to send, RTS, successfully transmitted by the first MLD,
a number of RTS failed transmitted by the first MLD, or
a number of unacknowledged frames transmitted by the first MLD.

In some embodiments, the frames comprise a quality of service, QOS, frame having a traffic indicator in a range of 0 to 7, and the statistic information comprises at least one of the following:
a number of QoS fragments transmitted by the first MLD,.
a number of QOS transmitted failures by the first MLD,
a number of QoS frames retransmitted by the first MLD,
a number of QoS frames multicast retransmitted by the first MLD,.
a number of QoS frames re-received by the first MLD,
a number of QOS RTS transmitted successfully,
a number of QOS RTS transmitted unsuccessfully,
a number of QOS unacknowledged frames transmitted by the first MLD,
a number of QOS fragments received by the first MLD,.
a number of QoS frames received by the first MLD,.
a number of QoS frames discarded by the first MLD,
a number of QoS medium access control (MAC) protocol data units, MPDUs, received by the first MLD, or.
a number of QoS retransmitted frames received by the first MLD.

In some embodiments, the frames comprises an aggregate medium access control (MAC) service data unit, A-MSDU, and the statistic information comprises at least one of the following:
a number of transmitted A-MSDUs by the first MLD,
a number of transmitted A-MSDU failures by the first MLD,
a number of transmitted bytes in an A-MSDU by the first MLD,.
a number of retransmitted A-MSDUs by the first MLD,
a number of multiple retransmitted A-MSDUs by the first MLD,
a number of unacknowledged A-MSDUs by the first MLD,
a number of received A-MSDUs by the first MLD, or.
a number of received bytes in an A-MSDU by the first MLD.

In some embodiments, the frames comprise an aggregate medium access control (MAC) protocol data unit, A-MPDU, and the statistic information comprises at least one of the following:
a number of A-MPDUs transmitted by the first MLD,
a number of MPDUs in an A-MPDU transmitted by the first MLD,
a number of bytes in an A-MPDU transmitted by the first MLD,.
a number of A-MPDUs received by the first MLD,.
a number of MPDUs in an A-MPDU received by the first MLD,.
a number of bytes in an A-MPDU received by the first MLD, or.
a number of A-MPDUs with cyclic redundancy check error received by the first MLD.

In some embodiments, the delay information comprises at least one of the following:
MLD average access delay,
MLD average delay on a quality of service QoS frame with a priority of best effort,
MLD average delay on the QoS frame with a priority of background,
MLD average delay on the QoS frame with a priority of video,
MLD average delay on the QoS frame with a priority of voice,
Non-AP MLD number, or
MLD channel utilization.

In some embodiments, the apparatus further comprises at least one antenna configured to facilitate communication.

In some example embodiments, an apparatus capable of performing the method 700 may comprise means for performing the respective steps of the method 700. The means may be implemented in any suitable form. For example, the means may be implemented in a circuitry or software module or a combination thereof.

In some example embodiments, an apparatus comprises a second MLD. The second MLD has: means for transmitting, to a first MLD, a request for at least one of statistic information associated with the first MLD or delay information associated with the first MLD; and means for receiving, from the first MLD, a report on the at least one of the statistic information or the delay information.

In some embodiments, the second MLD is configured to transmit the request for the at least one of the statistic information or the delay information by transmitting a station statistics request frame to the first MLD.

In some embodiments, the station statistics request frame comprises: a first address of a first MAC of the first MLD in a first subelement field, the first address indicating to request the at least one of the statistic information and the delay information associated with the first MLD.

In some embodiments, the second MLD is configured to receive a station statistics report frame, and the station statistics report frame comprises at least one of the following: the at least one of the statistic information or the delay information, or a first address of a first MAC of the first MLD or a second address of a second MAC entity of the second MLD in a second subelement field, the first address or the second address indicating that the at least one of the statistic information or the delay information is associated with the first MLD.

In some embodiments, the station statistics request frame comprises at least one of the following: a first address of a first MAC of the first MLD, the first address indicating to request the at least one of the statistic information or the delay information associated with the first MLD.

In some embodiments, the second MLD comprises a second SME and a second MLME. In some embodiments, the second SME is configured to provide a second request primitive to the second MLME so as to indicate that the request for the at least one of the statistic information or the delay information is to be transmitted.

In some embodiments, the second request primitive comprises at least one of the following: a first address of a first MAC of the first MLD, or a fourth address of a fourth MAC entity of a device affiliated with the first MLD, the fourth address indicating that the at least one of the statistic information or the delay information is to be transmitted to the device.

In some embodiments, the second request primitive comprises: a first address of a first MAC of the first MLD, the first address indicating that the at least one of the statistic information or the delay information is to be transmitted to any of devices affiliated with the first MLD.

In some embodiments, the second MLME is configured to provide a second indication primitive to the second SME so as to indicate the at least one of the statistic information or the delay information was received.

In some embodiments, the second indication primitive further comprises at least one of the following: the at least one of the statistic information or the delay information, a first address of a first MAC of the first MLD, or a fourth address of a fourth MAC entity of a device affiliated with the first MLD, the fourth address indicating that the at least one of the statistic information or the delay information is received from the device.

In some embodiments, the the second indication primitive further comprises at least one of the following: the at least one of the statistic information or the delay information, or a first address of a first MAC of the first MLD, the first address indicating that the at least one of the statistic information and the delay information is received from any of devices affiliated with the first MLD.

In some embodiments, the statistic information comprises at least one of the following:
a number of fragment frames transmitted by the MLD,
a number of multicast frames transmitted by the MLD,
a number of frames transmitted failures by the MLD,.
a number of fragment frames received by the MLD,.
a number of frames with frame check sequence error received by the MLD.
a number of fragment frames transmitted by the MLD,.
a number of frames retransmitted by the MLD,
a number of frames multiple retransmitted by the MLD,
a number of frames re-received by the MLD,.
a number of requests to send, RTS, successfully transmitted by the MLD,
a number of RTS failed transmitted by the MLD, or
a number of unacknowledged frames transmitted by the MLD.

In some embodiments, the frames comprise a quality of service, QOS, frame having a traffic indicator in a range of 0 to 7, and the statistic information comprises at least one of the following:
a number of QoS fragments transmitted by the MLD,
a number of QoS transmitted failures by the MLD,
a number of QoS frames retransmitted by the MLD,
a number of QoS frames multicast retransmitted by the MLD,.
a number of QoS frames re-received by the MLD,
a number of QOS RTS transmitted successfully,
a number of QOS RTS transmitted unsuccessfully,
a number of QOS unacknowledged frames transmitted by the MLD,.
a number of QOS fragments received by the MLD,.
a number of QoS frames received by the MLD,
a number of QoS frames discarded by the MLD,
a number of QoS MAC protocol data units, MPDUs, received by the MLD, or.
a number of QoS retransmitted frames received by the MLD.

In some embodiments, the frames comprises an A-MSDU and the statistic information comprises at least one of the following:
a number of transmitted A-MSDUs by the MLD,
a number of transmitted A-MSDU failures by the MLD,
a number of transmitted bytes in an A-MSDU by the MLD,
a number of retransmitted A-MSDUs by the MLD,.
a number of multiple retransmitted A-MSDUs by the MLD,
a number of unacknowledged A-MSDUs by the MLD,
a number of received A-MSDUs by the MLD, or
a number of received bytes in an A-MSDU by the MLD.

In some embodiments, the frames comprise an A-MPDU, and the statistic information comprises at least one of the following:
a number of A-MPDUs transmitted by the MLD,
a number of MPDUs in an A-MPDU transmitted by the MLD,
a number of bytes in an A-MPDU transmitted by the MLD,
a number of A-MPDUs received by the MLD,.
a number of MPDUs in an A-MPDU received by the MLD,
a number of bytes in an A-MPDU received by the MLD, or.
a number of A-MPDUs with cyclic redundancy check error received by the MLD.

In some embodiments, the delay information comprises at least one of the following:
MLD average access delay,
MLD average delay on a quality of service QoS frame with a priority of best effort,
MLD average delay on the QoS frame with a priority of background,
MLD average delay on the QoS frame with a priority of video,
MLD average delay on the QoS frame with a priority of voice,
Non-AP MLD number, or
MLD channel utilization.

In some embodiments, the second MLD is configured to transmit the request for the at least one of the statistic information or the delay information in response to receiving, from an access control device, a query request for the at least one of the statistic information or the delay information associated with the first MLD.

In some embodiments, the second MLD is configured to transmit, to the access control device, the at least one of the statistic information or the delay information associated with the first MLD.

In some embodiments, the second MLD further comprises at least one antenna configured to facilitate communication.

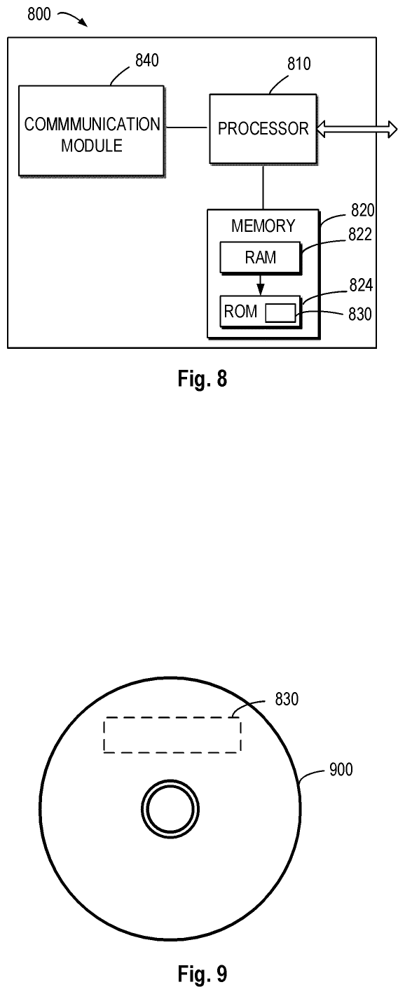

FIG. 8 is a simplified block diagram of a device 800 that is suitable for implementing embodiments of the present disclosure. The device 800 may be provided to implement the communication device, for example, the non-AP MLD 110 or the AP MLD 120 as shown in FIGS. 1A, 1B and 1C, the non-AP MLD 140 or 150 as shown in FIG. 1B, or the AP MLD 160 as shown in FIG. 1C. As shown, the device 800 includes one or more processors 810, one or more memories 820 coupled to the processor 810, and one or more communication modules 840 coupled to the processor 810.

The communication module 840 is configured for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the memory 820, e.g. ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 1 to 7. The embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, for the device to carry out the methods 600 and 700 as described above with reference to FIGS. 6 and 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

### List of Acronyms and Abbreviations

AP: access point
Non-AP MLD non-access-point multi-link device
MAC: medium access control
ML: multi-link
MLD: multi-link device
MLO: multi-link operation
QOS: quality of service
STA: station
MLME medium access control sublayer management entity
SME station management entity
MPDU medium access control (MAC) protocol data unit

1-41. (canceled)

42. A multi-link device, MLD, comprising:
at least one processor; and
at least one memory storing instructions that, when executed by the at least one processor, cause the MLD at least to:
determine at least one of statistic information associated with the MLD or delay information associated with the MLD; and
in response to receiving a request for the at least one of the statistic information or the delay information from a second MLD, transmit the at least one of the statistic information or the delay information to the second MLD.

43. The MLD of claim 42, wherein the MLD is configured to receive the request for the at least one of the statistic information or the delay information by:
receiving a station statistics request frame from the second MLD.

44. The MLD of claim 43, wherein the station statistics request frame comprises:
a first address of a first medium access control, MAC, entity of the MLD in a first subelement field, the first address indicating to request the at least one of the statistic information and the delay information associated with the MLD.

45. The MLD of claim 42, wherein the MLD is configured to transmit a station statistics report frame, and the station statistics report frame comprises at least one of the following:
the at least one of the statistic information or the delay information, or
a first address of a first medium access control, MAC, entity of the MLD or a second address of a second MAC entity of the second MLD in a second subelement field, the first address or the second address indicating that the at least one of the statistic information or the delay information is associated with the MLD.

46. The MLD of claim 43, wherein the station statistics request frame comprises:
a first address of a first medium access control, MAC, entity of the MLD, the first address indicating to request the at least one of the statistic information or the delay information associated with the MLD.

47. The MLD of claim 42, wherein the MLD comprises a first station management entity, SME, and a first medium access control sublayer management entity, MLME; and
wherein the first MLME is configured to provide a first indication primitive to the first SME so as to indicate that the request for the at least one of the statistic information or the delay information was received.

48. The MLD of claim 42, wherein the statistic information comprises at least one of the following:
a number of fragment frames transmitted by the MLD,
a number of multicast frames transmitted by the MLD,
a number of frames transmitted failures by the MLD,
a number of fragment frames received by the MLD,
a number of frames with frame check sequence error received by the MLD
a number of fragment frames transmitted by the MLD,
a number of frames retransmitted by the MLD,
a number of frames multiple retransmitted by the MLD,
a number of frames re-received by the MLD,
a number of requests to send, RTS, successfully transmitted by the MLD,
a number of RTS failed transmitted by the MLD, or
a number of unacknowledged frames transmitted by the MLD.

49. The MLD of claim 42, wherein the delay information comprises at least one of the following:
MLD average access delay,
MLD average delay on a quality of service QoS frame with a priority of best effort,
MLD average delay on the QoS frame with a priority of background,
MLD average delay on the QoS frame with a priority of video,
MLD average delay on the QoS frame with a priority of voice,
Non-AP MLD number, or
MLD channel utilization.

50. The MLD of claim 42, further comprising at least one antenna configured to facilitate communication.

51. A multi-link device, MLD, comprising:
at least one processor; and
at least one memory storing instructions that, when executed by the at least one processor, cause the MLD at least to:
transmit, to a first MLD, a request for at least one of statistic information associated with the first MLD or delay information associated with the first MLD; and
receive, from the first MLD, a report on the at least one of the statistic information or the delay information.

52. The MLD of claim 51, wherein the MLD is configured to transmit the request for the at least one of the statistic information or the delay information by:
transmitting a station statistics request frame to the first MLD.

53. The MLD of claim 52, wherein the station statistics request frame comprises:
a first address of a first medium access control, MAC, entity of the first MLD in a first subelement field, the first address indicating to request the at least one of the statistic information and the delay information associated with the first MLD.

54. The MLD of claim 52, wherein the station statistics request frame comprises at least one of the following:
a first address of a first medium access control, MAC, entity of the first MLD, the first address indicating to request the at least one of the statistic information or the delay information associated with the first MLD.

55. The MLD of claim 51, wherein the MLD is configured to receive a station statistics report frame, and the station statistics report frame comprises at least one of the following:
the at least one of the statistic information or the delay information, or
a first address of a first medium access control, MAC, entity of the first MLD or a second address of a second MAC entity of the MLD in a second subelement field, the first address or the second address indicating that the at least one of the statistic information or the delay information is associated with the first MLD.

56. The MLD of claim 51, wherein the MLD comprises a second station management entity, SME, and a second medium access control sublayer management entity, MLME; and
wherein the second SME is configured to provide a second request primitive to the second MLME so as to indicate that the request for the at least one of the statistic information or the delay information is to be transmitted.

57. The MLD of claim 51, wherein the statistic information comprises at least one of the following:
a number of fragment frames transmitted by the MLD,
a number of multicast frames transmitted by the MLD,
a number of frames transmitted failures by the MLD,
a number of fragment frames received by the MLD,
a number of frames with frame check sequence error received by the MLD
a number of fragment frames transmitted by the MLD,
a number of frames retransmitted by the MLD,
a number of frames multiple retransmitted by the MLD,
a number of frames re-received by the MLD,
a number of requests to send, RTS, successfully transmitted by the MLD,
a number of RTS failed transmitted by the MLD, or
a number of unacknowledged frames transmitted by the MLD.

58. The MLD of claims 51, wherein the delay information comprises at least one of the following:
MLD average access delay,
MLD average delay on a quality of service QoS frame with a priority of best effort,
MLD average delay on the QoS frame with a priority of background,
MLD average delay on the QoS frame with a priority of video,
MLD average delay on the QoS frame with a priority of voice,
Non-AP MLD number, or
MLD channel utilization.

59. The MLD of claim 51, wherein the MLD is configured to transmit the request for the at least one of the statistic information or the delay information in response to receiving, from an access control device, a query request for the at least one of the statistic information or the delay information associated with the first MLD.

60. A method, comprising:
determining, at a multi-link device, MLD, at least one of statistic information associated with the MLD or delay information associated with the MLD; and
in response to receiving a request for the at least one of the statistic information or the delay information from a second MLD, transmitting the at least one of the statistic information or the delay information to the second MLD.

61. A method, comprising:
transmitting, from a multi-link device, MLD to a first MLD, a request for at least one of statistic information associated with the first MLD or delay information associated with the first MLD; and
receiving, from the first MLD, a report on the at least one of the statistic information or the delay information.
